(19) United States
(12) Patent Application Publication
(10) Pub. No.: US 2016/0050137 A1
(43) Pub. Date: Feb. 18, 2016

(54) SYSTEM AND METHOD OF PROVIDING LEAST-COST ROUTING OF CALLS

(71) Applicant: Calero Software, LLC, Rochester, NY (US)

(72) Inventors: Christopher Jurasek, Las Vegas, NV (US); Rakesh Kushwaha, Marlboro, NJ (US); Thomas McAlees, Victor, NY (US)

(73) Assignee: Calero Software, LLC, Rochester, NY (US)

(21) Appl. No.: 14/457,710

(22) Filed: Aug. 12, 2014

(51) Int. Cl. H04L 12/721

(52) U.S. Cl. CPC H04L 45/12

(57) ABSTRACT

A private network associated with an enterprise interconnects multiple points of presence (POPs) located in regions in which communications devices associated with the enterprise operate. In addition, the communications devices and POPs are each connected to the public switched telephone network (PSTN) and/or the Internet, or collectively, public network. Upon origination of a call from a device, a call management agent (CMA) on the device determines, based at least in part on the intended destination of the call, whether to allow the call to proceed conventionally over the public network, or whether to direct the call to a first POP for conveyance over the private network to a second POP, and from the second POP to the called device. The determination made by the CMA as to how to direct the outgoing call is based on minimizing the cost thereof. A call management server may be provided from which the CMA can obtain current cost and network information for use in making the aforementioned determination.

### FIELD OF THE INVENTION

The disclosed invention relates generally to communications, particularly to the routing of calls between communications devices.

### BACKGROUND INFORMATION

For enterprises with personnel distributed over wide geographical areas, the costs associated with providing them with voice and data connectivity can become quite significant, particularly when connection and toll charges are incurred. Most calling plans offered by service providers typically apply only to the home region or the home country of the service provider or subscriber. When mobile devices roam into other service provider networks or other countries, roaming charges and/or long distance calling rates may apply. The costs of calls when a mobile device is outside of its home region can therefore be quite substantial and are typically set at the visited carrier's discretion.

Traditionally, voice calls have been carried over circuit-switched networks operated by various telephone service providers. Long distance calls will typically entail toll charges and thus cost more than local calls, with the costs typically borne by the calling party.

Voice calls can also be carried out using Voice-over-Internet-Protocol (VoIP) in which voice is carried as packets over a wide area packet-switched network, such as the Internet, using Internet Protocol (IP). In mobile telephony, such as in a 3G environment, voice services are typically handled by a circuit-switched network, whereas data services are handled by the Internet. Alternatively, voice calls can be handled by the Internet using an over-the-top (OTT) VoIP service, such as SKYPE or the like. While circuit-switched calls may be subject to long distance charges, OTT VoIP requires data service, which typically entails additional costs for the subscriber. Moreover, additional charges typically apply when calling destinations not on the OTT VoIP service provider's network, such as conventional, circuit-switched devices and devices. The same is true of VoIP calls originating in a 4G network where the destination is outside the 4G carrier's network.

### SUMMARY OF THE INVENTION

An aspect of embodiments of the disclosed invention generally relates to establishing least-cost paths for calls from communications devices. An exemplary embodiment of the disclosed invention involves a communications device that is capable of voice connectivity. In an aspect of the disclosed invention, the communications device is configured with a call management agent (CMA) that directs the routing of outgoing calls from the device so as to eliminate or minimize toll charges, such as long-distance calling charges.

In a typical embodiment, it is contemplated that a point of presence (POP) is present in each of two or more regions in which voice communications devices associated with an enterprise operate. The at least two POPs are interconnected, such as via a network associated with the enterprise, referred to herein as a private network. In addition, the at least two POPs are each connected to the public switched telephone network (PSTN) and/or the public packet-switched network, or the Internet, collectively referred to herein as the public network.

Upon origination of a call from a device, the device's CMA determines, based at least in part on the intended destination of the call, whether to allow the call to proceed conventionally over the public network, or whether to direct the call to a first POP for conveyance over the private network to a second POP, and from the second POP ultimately to the called device.

In exemplary embodiments, the determination made by a device's CMA as to how to direct an outgoing call is based on minimizing the cost of the call. In an illustrative scenario, if the cost of handling the call over the alternative route—i.e., the combined cost of the leg of the call between the calling device and the first POP, the leg between the first and second POPs, and the leg between the second POP and the called device—is less than the cost of a conventional call from the calling to the called device over the public network, then the CMA directs the call to the first POP for conveyance over the private network to the second POP and from the second POP ultimately to the called device. Otherwise, the CMA allows the call to proceed conventionally over the public network.

In a further aspect of the disclosed invention, a call management (CM) server is provided from which the CMA can obtain cost and network information used by the CMA in making the aforementioned determination.

The above and other aspects and features of the disclosed invention will be apparent from the drawings and detailed description which follow.

### BRIEF DESCRIPTION OF THE DRAWINGS

FIG. 1 is a block diagram of an illustrative system in which embodiments in accordance with the disclosed invention can be implemented, the system including network elements interconnecting geographically distributed communications devices.

FIG. 2 is a flowchart illustrating an exemplary method of operation of a communications device in accordance with the disclosed invention.

FIG. 3 is a flowchart illustrating an exemplary method of operation in accordance with the disclosed invention.

FIG. 4 is a flowchart illustrating an exemplary method of operation of a communications device in accordance with the disclosed invention.

### DETAILED DESCRIPTION

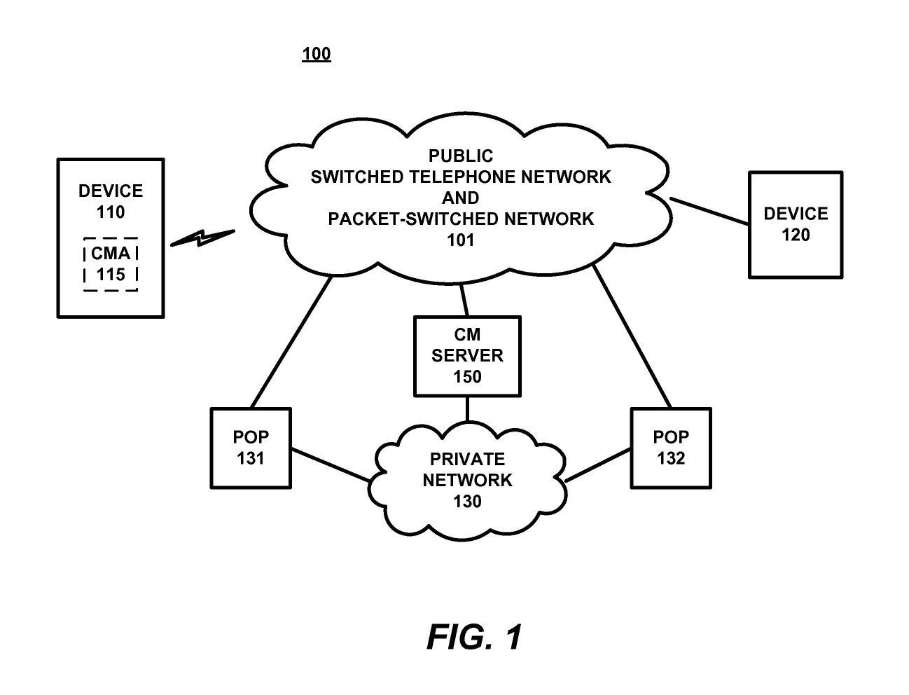

FIG. 1 is a block diagram of an illustrative system 100 in which embodiments in accordance with the disclosed invention can be implemented. System 100 includes public communications network 101, which can be thought of as including the so-called public switched telephone network (PSTN), the aggregate of the world's circuit-switched telephone networks, as well as the public packet-switched network, or the Internet. Various portions of network 101 are operated by national, regional, or local telephony and/or internet service providers, providing wired and wireless infrastructure and services for public telecommunication.

In addition to public network 101, system 100 includes a private communications network 130, which may be circuit-switched and/or packet-switched. Private network 130 may be, for example, a dedicated communications network, a virtual network, or an intranet, among other possibilities, interconnecting geographically distributed assets of an enterprise over various regions. Although private network 130 can be implemented with its own infrastructure (e.g., trunks, switches, routers), distinct from that of network 101, private network 130 may also be implemented over network 101 using resources thereof dedicated to network 130 on a temporary or permanent basis, such as in the case of virtual private networks (VPNs), nailed-up circuit switched connections, or the like. Furthermore, access to private network 130 is preferably secure and limited to assets and users associated with the enterprise.

As shown in FIG. 1, private network 130 interconnects various, typically geographically distributed, points of presence (POPs) associated with the enterprise. Two POPs 131 and 132 are shown in FIG. 1. In addition to being interconnected by private network 130, the POPs are also connected to public network 101. In addition to being able to intercommunicate via private network 130, POPs 131 and 132 preferably may also be able to intercommunicate via public network 101. POPs 131 and 132, may include, for example, private branch exchanges (PBXs), IP-PBXs, or the like, and may also preferably include gateway functionality between packet- and circuit-switched networks.

FIG. 1 will now be further described with reference to the handling of an illustrative voice call originating from a first, calling device 110 to a second, called device 120. In this case, calling device 110 is a wireless mobile device, such as a smartphone or the like, connected to network 101 and called device 120 is a landline device, such as an analog or VoIP telephone or the like, connected to network 101. In exemplary embodiments, device 110 is a processor-based device that can be configured to operate as described herein. Moreover, for purposes of this discussion, in addition to any charges incurred in connecting to network 101, calling device 110 is also assumed to incur additional charges, such as toll charges or the like, for public network 101 to complete and carry the call with called device 120.

Conventionally, the entire voice call from device 110 to device 120 is handled by network 101. As contemplated by the disclosed invention, however, a voice call from device 110 to device 120 can alternatively be routed, preferably at a lower cost, via private network 130 using POPs 131 and 132. Moreover, POPs 131 and 132 are selected so that calls between device 110 and POP 131, and calls between device 120 and POP 132, are preferably toll-free or local calls or at least minimize the overall cost of the entire call between devices 110 and 120.

As further shown in FIG. 1, mobile device 110 includes a call management agent (CMA) 115 which serves to manage the routing of voice calls originating from mobile device 110. As described in greater detail below, CMA 115 determines which path through system 100 an outgoing call from device 110 to a called device will take. In exemplary embodiments, such a determination is based on identifying the lowest cost alternative available at the time of the call, given the network locations of the calling and called devices. Information used by CMA 115 to make this determination is preferably obtained from a call management (CM) server 150 and is preferably updated periodically or as needed. Alternatively, CMA is pre-programmed with the information, or a user or administrator inputs the information and/or updates thereof, among other possibilities.

In exemplary embodiments, CM server 150 aggregates information about private network 130 and associated POPs, such as network configuration, equipment type and capabilities, physical location, circuit-switched exchange, local dialing area, and other information that may be used to determine the least costly route for a call in accordance with the exemplary arrangement. CM server 150 also preferably aggregates information about mobile devices participating in the exemplary call routing arrangement described herein. Such information may include, for example, calling plan information, last known physical (e.g., GPS) and/or network location, network address (e.g., phone number, IP address, and last known carrier network. CM server 150 also preferably aggregates information such as tariff data, location information, call jurisdiction and the like that may be used in the determination of the least costly route for a call. The various information aggregated by CM server 150 may be captured, for example, through automated system-to-system interfaces or a web-based user interface and stored for subsequent use.

CMA 115 uses the aforementioned information from CM server 150 to determine the least costly route for a call given the current location of the calling device, the dialed number, calling plan rates including any toll charges, and private network configuration.

In exemplary embodiments, CM server 150 is implemented, for example, as part of a device management server or separately. CM server 150 can be implemented, for example, using conventional server hardware programmed with software to operate as described herein. CM Server 150 preferably has one or more secure application programming interfaces (APIs) accessible by CMA 115 over public network 101 or private network 130.

CMA 115 can be implemented, for example, as a software application running on the device 110. In exemplary embodiments, CMA 115 can be downloaded to device 110 from CM server 150, a device management server, an application server, or the like.

Preferably, if CM server 150 is unavailable or unreachable, CMA 115 is able to function with the most recently obtained information stored locally. Of course if the public or private network, device location, and/or costs have changed since the last update, it is possible that the route recommended by CMA 115 may be sub-optimal.

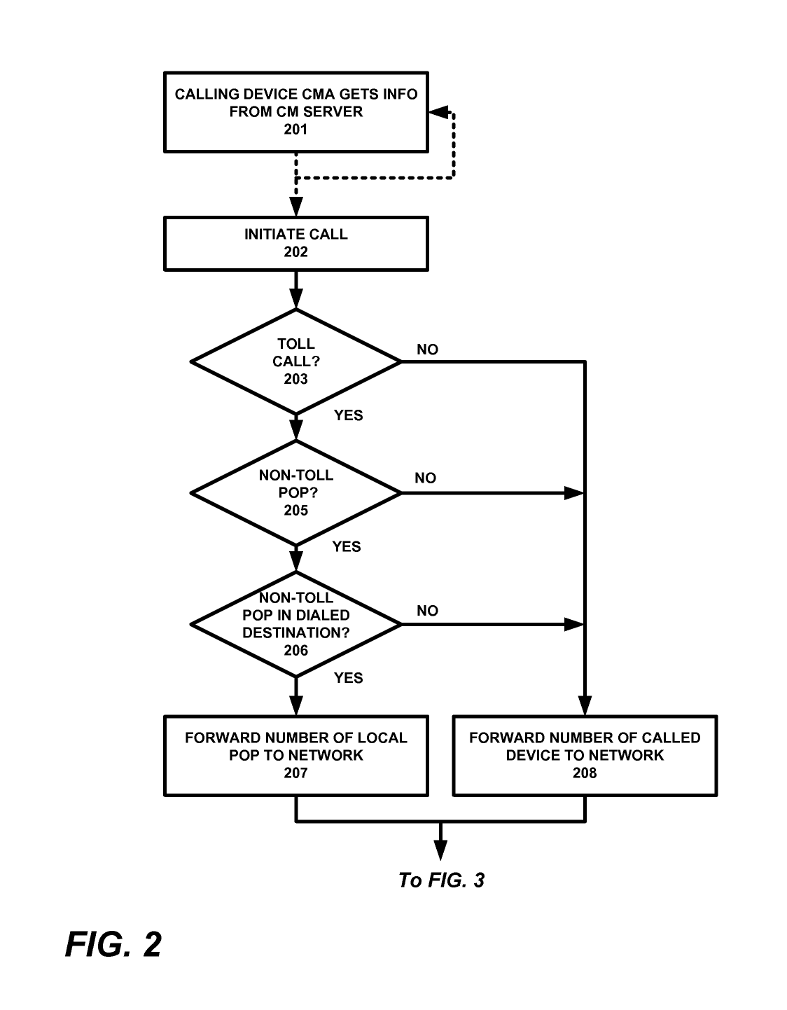

An exemplary method of operation of device 110 and in particular CMA 115 will now be described in greater detail with reference to the flowchart shown in FIG. 2.

As represented by block 201, CMA 115 obtains information from CM server 150. Such information may include, for example, least cost routing (LCR) information, and information relating to private network 130 and POPs 131, 132 shown in FIG. 1. LCR information may include, for example, country codes and exchanges that can be called from the device and the costs associated with each given the device's current location. Private network information may include, for example, network addresses (e.g., telephone numbers, IP addresses) associated with the POPs and signaling and security details necessary to complete a call using private network 130.

Preferably, CMA 115 periodically synchronizes and caches information from CM server 150 so as to keep current with any changes in information relevant to device 110. In an exemplary embodiment, CMA 115 is aware of the network location of device 110 and provides that information to CM server 150. CM server 150 uses this information to select and provide information that is relevant to device 110 given its network location. Moreover, when CMA 115 detects a change in network location of device 110, it preferably contacts CM server 150 to obtain new information based on the change.

At some point, as represented by block 202, a user of device 110 will seek to place an outgoing call, such as by invoking the calling functionality or dialer utility of device 110. Once the user has specified the identity of the called device, such as by entering the telephone number of the called device or selecting it from a list of contacts or call log, CMA 115 determines at 203 whether toll charges would apply to a conventional call entirely over network 101, given the destination of the call, the current network location of device 110 and the applicable calling plan.

It should be noted that embodiments of the disclosed invention are not limited to either circuit-switched or VoIP calls or any combination thereof. Each of the calling device 110 and called device 120 can be a circuit-switched voice or VoIP device. The types of devices or how they connect to network 101 may, however, be relevant in determining the costs associated with the call and thus in determining whether or not to use private network 130 for any portion of the call.

At 203, if CMA 115 determines that the call that device 110 seeks to place would not be a toll call, operation proceeds to 208 in which the device 110 sends a call request to public network 101 specifying the phone number of the called device as the destination of the call. The call is then set up and proceeds conventionally over network 101.

If, however, CMA 115 determines at 203 that the call would be a toll call, operation then proceeds to 205 in which CMA 115 determines, based on the calling device's current network location, calling plan and network information, such as obtained from CM server 150, whether or not there is a point of presence (POP) with which device 110 can communicate without toll charges, such as POP 131 of FIG. 1. If not, operation proceeds to 208, as described above. If CMA 115 determines that there is such a POP, operation then proceeds to 206 in which CMA 115 determines whether or not there is also a POP that can communicate with the called device without toll charges. If not, operation proceeds to 208, as described above. If there is, such as POP 132 in the case of called device 120 of FIG. 1, operation proceeds to 207 in which the calling device 110 sends a call request to network 101, specifying the phone number of the POP with which device 110 can communicate without toll charges (i.e., POP 131).

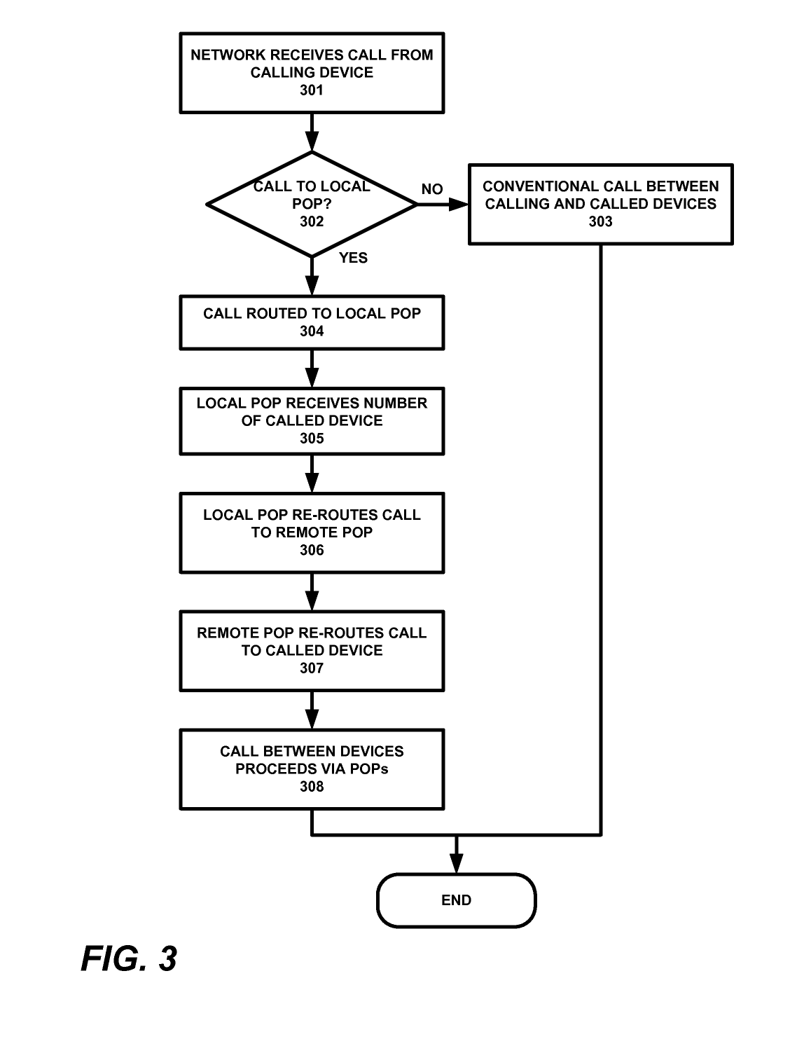

Once a call has been placed by the calling device, operation then proceeds as illustrated in FIG. 3. At 301, network 101 receives the call and forwards it in accordance with the destination telephone number specified by the call request. If, as determined at 302, the call was not directed to POP 131 but rather to the called device 120, operation proceeds to 303 in which a call to the called device is carried out in a conventional manner over public network 101. If, however, the call is directed to POP 131, the call is routed at 304 by network 101 to POP 131.

Once the call is routed to POP 131, operation then proceeds to 305, in which local POP 131 receives from the calling device 110, under the direction of CMA 115, the network address (e.g., telephone number, IP address) of the called device 120. The conveyance of such information between calling device 110 and POP 131 can be effected, for example, using in-band signaling, such as dual-tone multi-frequency (DTMF) signaling. In the case of VoIP, such information can also be conveyed using session initiation protocol (SIP) messaging.

At 306, based on the network address of the called device received from the calling device, the local POP 131 identifies a remote POP that can communicate with the called device with a toll-free connection, such as POP 132 in the case of called device 120 of FIG. 1. In an exemplary embodiment, POP 131 is configured with rules that control how a call is to be handled based on the network address of the called device, such as by re-routing the call to a POP that is local (i.e., within a toll-free connection) to the called device or nearest (i.e., within the lowest-cost connection) to the called device. In an exemplary embodiment, such rules are preferably updated using information from CM server 150.

It should be noted that as described above, CMA 115 of calling device 110 has already determined at 206 whether there is a POP that is local to the called device, such as POP 132 in the case of called device 120. In an exemplary embodiment, CMA 115 can convey the identity and/or network address of POP 132 to POP 131, which POP 131 can use instead of or in addition to determining it by itself.

Local POP 131 then re-routes the call from calling device 110 to remote POP 132 via the lowest cost route available, as ostensibly provided by private network 130. In communicating with remote POP 132, local POP 131 provides remote POP 132 with the telephone number of the called device 120.

If POP 131 is unable to communicate with POP 132 via private network 130, POP 131 may attempt to communicate with POP 132 using network 101, assuming doing so is cost effective: e.g., it is not as costly as allowing the call to proceed conventionally. If such an attempt fails or is not cost effective, POP 131 may decline to complete the call from device 110, thereby signaling to CMA 115 to try to originate the call again or to originate the call as a conventional call. If POP 131 cannot communicate with POP 132 over either network 101 or 130, CMA 115 can re-attempt the call to POP 131 or decide to originate the call as a conventional call over network 101. Preferably, how CMA 115 handles such situations is user- or administrator-configurable, for example.

At 307, remote POP 132 re-routes the call from POP 131 to called device 120 via public network 101.

Assuming the called device answers the call, operation then proceeds to 308 in which the call between the calling device 110 and the called device 120 is completed via POPs 131, 132 and private network 130, with toll-free legs between calling device 110 and POP 131 and POP 132 and called device 120, respectively.

Depending on the nature of communications devices 110 and 120 and/or costs, the various legs of the call can be handled using circuit- or packet-switched resources. In an exemplary embodiment, if calling device 110 uses circuit-switched voice calling and called device 120 uses VoIP, the leg of the call between device 110 and POP 131 is handled by network 101 similarly to a circuit-switched call. POP 131, which preferably includes an IP gateway, re-routes the call as a VoIP call via private network 130, POP 132 and network 101 to called device 120.

In a further exemplary embodiment, if calling device 110 uses VoIP and called device 120 uses circuit-switched voice calling, the leg of the call between device 110 and POP 131 is handled by network 101 similarly to a VoIP call. POP 131 re-routes the call via private network 130 to POP 132, which preferably includes an IP gateway, which completes the call as a circuit-switched call over network 101 to called device 120.

In a further exemplary embodiment, if both calling device 110 and called device 120 use circuit-switched voice calling, the leg of the call between device 110 and POP 131 is handled by network 101 similarly to a circuit-switched call. POP 131 re-routes the call via private network 130 to POP 132, which completes the call as a circuit-switched call over network 101 to called device 120. Depending on the relative costs, resource availability, and/or time constraints, among other possible considerations, the leg of the call between POPs 131 and 132 can be handled as a circuit-switched call or a VoIP call. If handled using VoIP, POPs 131 and 132 would include IP gateways in this scenario.

In yet a further exemplary embodiment, if both calling device 110 and called device 120 use VoIP, the leg of the call between device 110 and POP 131 is handled by network 101 similarly to a VoIP call as is the leg between POP 132 and called device 120. Depending on the relative costs, resource availability, and/or time constraints, among other possible considerations, the leg of the call between POPs 131 and 132 can be handled as a circuit-switched call or a VoIP call. If handled as a circuit-switched call, POPs 131 and 132 would include IP gateways in this scenario.

In exemplary embodiments, calling device 110 may have both circuit-switched and VoIP capability. In that case, CMA 115 has the option to originate an outgoing call as a circuit-switched call or a VoIP call. The determination as to which option to use can be based, for example, on cost and availability.

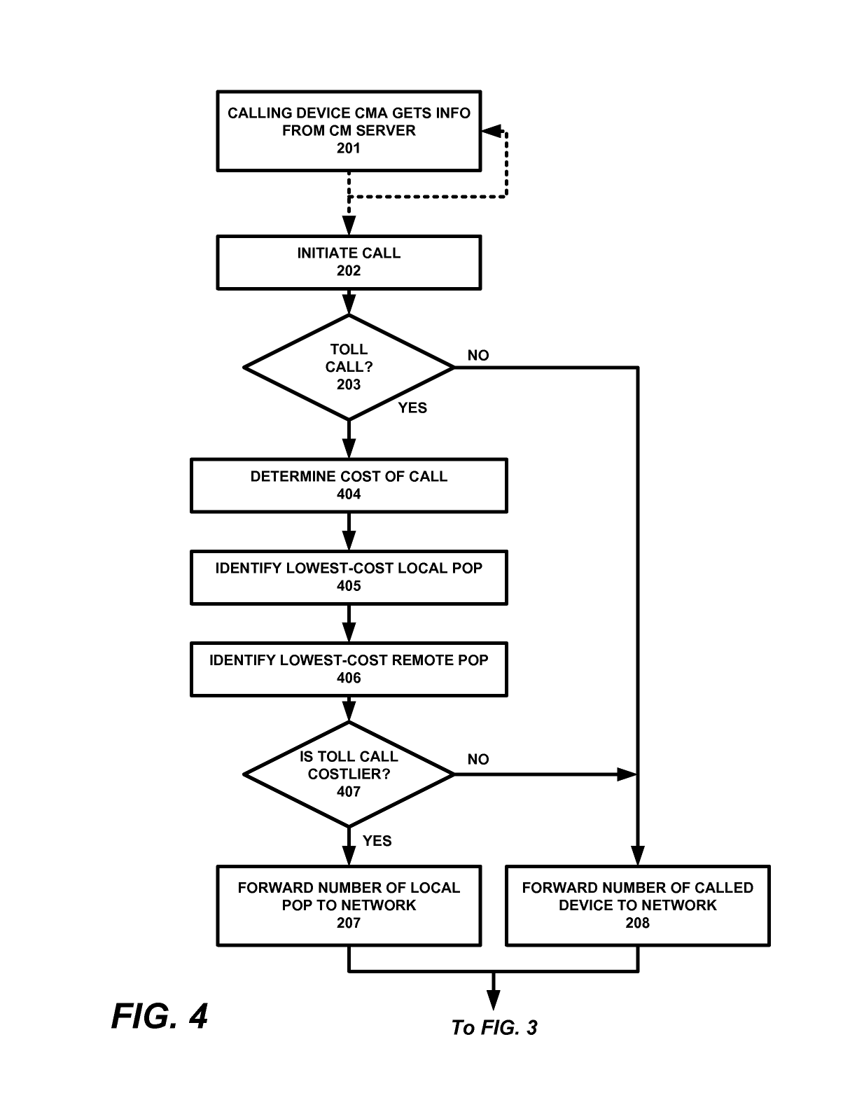

In the above illustrative description, it is assumed that the POPs are local or within toll-free connections to the calling and called devices. Where this is not the case, there may, however, be POPs close enough to the calling and called devices so that a call routed via the POPs and the private network is nonetheless less costly than a conventional call. In exemplary embodiments, CMA 115 is preferably capable of identifying those POPs that will yield the lowest cost communication, even if one or more of the POPs is not local to the calling and/or called device. An exemplary method of operation of device 110 and in particular CMA 115 will now be described with reference to the flowchart shown in FIG. 4. The description above of FIG. 2 applies to the similarly labeled blocks of FIG. 4.

Referring now to FIG. 4, at some point as represented by block 202, a user of device 110 will seek to place an outgoing call, as described above. At 203, if CMA 115 determines that the call that device 110 seeks to place would not be a toll call, operation proceeds to 208 in which the device 110 sends a call request to network 101 specifying the phone number of the called device as the destination of the call. The call is then set up and proceeds conventionally over network 101.

If, however, CMA 115 determines at 203 that the call would be a toll call, operation then proceeds to 404 in which CMA 115 determines—based on the calling and called devices' current network locations, calling plan and network information, such as obtained from CM server 150—what the cost of the call would be (typically per some unit of time) if carried conventionally over network 101.

Operation then proceeds to 405 in which CMA 115 determines—based on the calling device's current network location, calling plan and network information, such as obtained from CM server 150—the POP with which device 110 can communicate at the lowest cost and the cost of doing so. Additionally, at 406, CMA 115 determines, based on the current network location of the called device 120 and the latest information obtained from CM server 150, the POP with which device 120 can communicate at the lowest cost and the cost of doing so.

Operation then proceeds to 407 in which CMA 115 compares the cost of the toll call as determined in 404 against the cost of routing the call via private network 130, as determined in 405 and 406. If the toll call is no costlier, operation proceeds to 208 in which the device 110 sends a call request to network 101 specifying the phone number of the called device as the destination of the call. The call is then set up and proceeds conventionally over network 101. Otherwise, operation proceeds to 207 in which the calling device 110 sends a call request to network 101, specifying the phone number of the POP identified in 405, with which device 110 can communicate at lowest cost. As in the case of FIG. 2, once a call has been placed by the calling device, operation then proceeds as illustrated in FIG. 3.

In exemplary embodiments, the phone number associated with a calling device is displayed to recipients of calls from the calling device, even when the call has been routed via enterprise POPs. In an exemplary embodiment, when a call from device 110 to device 120 is routed over private network 130, POP 131 and/or 132 is/are configured so that the automatic number identification (ANI) information of calling device 110 is provided by network 101 to called device 120. As a result, the number associated with device 110 is presented to called device 120 as the caller phone number independently of which path the call takes to the called device.

In exemplary embodiments, either or both calling device 110 and called device 120 is directly connected to POP 131 or 132, respectively. In such cases, while routing the call via the private network 130 will usually be less costly than using public network 101, if private network 130 is unavailable or is not less costly, it is possible for POPs 131 and 132 to intercommunicate via network 101 instead.

Additionally, while embodiments have been described with two POPs, a call can be routed over the private network using more than two POPs and/or other network elements. This will typically depend, for example, on the configuration of the private network and/or the availability of resources at the time of the call.

A consideration in embodiments of the disclosed invention is security. In an exemplary embodiment, communications devices are registered with one or more POPs and/or CM server 150. Each POP is provided with a list of authorized origination numbers associated with devices that are allowed to use private network 130. If a POP receives a call from an unauthorized number, it will reject the call and not re-route it to another POP as described above. In an exemplary embodiment, a token arrangement or the like is used for the authentication of devices to POPs.

It is understood that each block of the flowchart illustrations and/or combinations thereof can be implemented with computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

It is understood that the embodiments disclosed herein are illustrative of only a few of the possible specific embodiments which can represent applications of the disclosed invention. The above specification, examples, and data provide a complete description of the implementation and use of the invention. Since many embodiments of the invention can be made without departing from the spirit and scope of the invention, the invention resides in the claims hereinafter appended.

What is claimed is:

1. A method for providing least-cost routing of calls between communications devices comprising:
initiating a call at a first communications device to a second communications device, the first and second communications devices each being coupled to a public communications network;
identifying a first point of presence for communicating with the first communications device via the public communications network;
identifying a second point of presence for communicating with the second communications device via the public communications network, the first and second points of presence each being coupled to the public communications network and to a private communications network;
directing the call from the first communications device to the first point of presence; and
communicating to the first point of presence a network address of the second communications device so that the call is routed via the private communications network and the second point of presence to the second communications device.

2. The method of claim 1, wherein the first communications device and the first point of presence communicate via the public communications network.

3. The method of claim 2, wherein communications between the first communications device and the first point of presence are toll free.

4. The method of claim 1, wherein the second communications device and the second point of presence communicate via the public communications network.

5. The method of claim 4, wherein communications between the second communications device and the second point of presence are toll free.

6. The method of claim 1, wherein the cost of the call is less than the cost of a call between the first and second communications devices via the public communications network.

7. The method of claim 6, wherein determining that the cost of the call is less than the cost of the call between the first and second communications devices via the public communications network includes determining a cost of the first communications device communicating with the first point of presence and a cost of the second communications device communicating with the second point of presence.

8. The method of claim 1 comprising receiving information from a call management server and using the information for identifying at least one of the first and second points of presence.

9. The method of claim 8, wherein the information includes at least one of a cost information and a network configuration information.

10. The method of claim 1, wherein identifying the first and second points of presence includes determining with which points of presence the first and second communications devices can communicate at lowest cost.

11. The method of claim 1, wherein the first communications device provides an indication of the second point of presence to the first point of presence.

12. The method of claim 1, wherein the first point of presence identifies the second point of presence based on the network address of the second communications device.

13. The method of claim 1, wherein caller identification information provided to the second communications device includes an indication of the first communications device.

14. The method of claim 1, wherein at least a portion of the call is in accordance with a voice over internet protocol (VoIP).

15. The method of claim 1 comprising authenticating the first communications device to the first point of presence.
